(19) United States
(12) Patent Application Publication
(10) Pub. No.: US 2009/0138281 A1
(43) Pub. Date: May 28, 2009

(54) Patient-controlled medical information system and method

(76) Inventor: Leonard Hacker, Washington, DC (US)

Correspondence Address: The Marbury Law Group, PLLC, 11800 SUNRISE VALLEY DRIVE, SUITE 1000, RESTON, VA, 20191, US

(21) Appl. No.: 11/946,625

(22) Filed: Nov. 28, 2007

(51) Int. Cl. G06Q 50/00

(52) U.S. Cl. 705/3

(57) ABSTRACT

An electronic medical record system and service is disclosed for centrally storing patients' medical records electronically on a database for patient-controlled remote access by both patients and medical providers. The system stores a plurality of patient medical records on a medical information database via a medical information server connected to a network. A plurality of medical provider computers connected to the network have software to communicate with the medical information server. Patients supply authorization means to allow medical provider computers to access patient-selected portions of the patient's medical record for viewing and updating of the patient's medical record. Patients can access all portions of their medical record using browser software on any browser-enabled device connected to the network, and can download and carry a full or partial copy of their medical record on portable storage media.

### BACKGROUND

Embodiments are drawn to an electronic medical record system and service for centrally storing patients medical records electronically on a database for patient-controlled remote access by both patients and medical providers wherein the patient can copy selected information to portable data storage media for physical control of information access by the patient.

While the technology has been developed to provide the capability of storing medical records electronically, the use and implementation of electronic medical records has not developed significantly beyond the traditional physician-controlled medical record system based on paper medical records as discussed in the present inventors prior U.S. Pat. No. 6,988,075, which is hereby incorporated by reference.

U.S. Pat. No. 6,988,075 discloses a patient-controlled medical information system and method that differed from prior art medical information systems in the ability of the patient to access and control their medical data. This system is implemented on the Internet, so remote access is provided anywhere with Internet access and no specialized software other than a browser client is required by patients and medical providers. Medical providers can include pharmacies, medical laboratories, doctors, hospitals, and nurses.

As the Information Age has allowed more and more personal data to be collected, stored, used, and often even sold, privacy concerns of patients have assumed more importance. Many of the prior art electronic medical record systems have included mechanisms to provide some amount of privacy for patients by limiting access to medical records to authorized medical personnel, but have not allowed patients to decide which medical personnel will be authorized.

Embodiments illustrated herein extend the patient control provided by U.S. Pat. No. 6,988,075 through the ability for the patient to physically control a copy of their medical information, whether complete or a portion thereof, on portable data storage media.

### BRIEF SUMMARY OF THE INVENTION

Embodiments illustrated herein relate to a system and service for centrally storing patients' medical records electronically on a database for patient-controlled remote access by both patients and medical providers over a public network or via patient-carried portable data storage media.

One embodiment provides patients greater access to and control over their medical records.

Another embodiment provides remote access to electronic medical records by patients or patient-authorized medical providers via a network, such as the Internet, using ordinary browser software or via patient-carried portable data storage media.

Yet another embodiment provides patient control over access to their records by using a patient supplied identifier, such as an ID/passphrase combination, bar code, smart card, or biometric sample, in order to access the electronic medical record.

Still another embodiment provides emergency access to patients' electronic medical records and notification of such access to patients.

### BRIEF DESCRIPTION OF THE DRAWINGS

FIG. 1 illustrates an overview of the elements involved with the various embodiments herein.

FIG. 2 illustrates an example of a display screen for patient access to their medical record in accordance with various embodiments.

FIG. 3 illustrates a second example of a display screen for patient access to their medical record in accordance with various embodiments.

FIG. 4 illustrates a third example of a display screen for patient access to their medical record which includes viewing tools in accordance with various embodiments.

FIG. 5 illustrates some of the options with respect to parties and communication mediums for interfacing with the various embodiments herein.

### DETAILED DESCRIPTION

Embodiments of the medical information system and service electronically store patient medical records on a database and allow for remote access to the records by medical providers and patients. Patients control access to their record by physically carrying a copy of their medical information on portable data storage media and providing a unique access identification means when the media is accessed by a medical provider. The following terms used herein have the following meaning:

The term “medical” as used with both records and providers refers to generally accepted health-related areas served by physicians (M.D.s), surgeons, dentists, diagnostic clinicians, physical therapists, medical nurses, pharmacists, chiropractors, acupuncturists, and homeopaths.

The term “browser” and “browser client” refer to generally available software programs which allows a person to read hypertext, such as, but not limited to, Netscape, Internet Explorer, Mozilla, Firefox, Opera, Safari, Konquerer, iCab, and W3 for personal computers and other devices, such as WAP-enabled software on wireless phones and other mobile computing devices, including but not limited to automotive/navigational systems, Web-enabled PDAs (e.g., iPod Touch), and smartphones (e.g., iPhone).

The term “patient-carried portable data storage media” refers to optical storage discs, such as compact discs (CDs) and digital versatile discs (DVDs), portable hard disc drives (HDDs), such as bus-powered portable USB2 and FireWire mini hard drives and hard drive-based iPods (e.g., iPod Classic), portable Flash drives, such as USB thumb drives and Flash memory iPods (e.g., iPod Nano), and Flash memory cards, such as CompactFlash (CF) cards, SmartMedia cards, xD-Picture cards, MultiMediaCards (MMCs), Secure Digital (SD) cards, Memory Stick cards, RS-MMC cards, miniSD cards, microSD cards, and Intelligent Stick cards. The term also refers to smart cards as well as memory chips embedded into the patient or items worn by the patient.

Although the embodiments of the system can use any suitable means for providing a unique access identification for each patient, including assigned alpha-numeric passphrases, smart cards, and biometric samples (voiceprint, fingerprint, retina scan, DNA-ink, etc.), a preferred embodiment for network access is a card (or bracelet for hospitalized patients) with a unique bar code for each patient. A preferred embodiment for access to patient-carried portable data storage media may be, without limitation a fingerprint-accessed USB flash drive.

In one embodiment, patients 101 register with a service to have their medical records stored electronically by any suitable means on a medical information database 110. The database 110 is connected to a system server 120 that is connected to a publicly accessible network 130, which may be the Internet. Medical providers 140 have computers (PCs), handheld devices/personal digital assistants (PDAs), or other browser-enabled appliances or devices 150 for uploading and downloading/viewing medical data. Appropriate means for input of the unique access identification means, such as bar code readers (BCRs) 160 for bar coded cards and bracelets, can be used for patient identification and access to network-stored information. Particularly sensitive patient information can be passphrase-protected so that the medical provider must get permission from the patient to gain access to it. The patient can also specify an emergency override of passphrase protection, and notification to the patient can be provided as to what information was released to emergency medical personnel, including time, location, pages accessed, etc.

When patients have allowed access to network-stored information or information on patient-carried portable data storage media, medical providers 140 can view appropriate portions of the patients medical record, and add information to the patient's medical record where appropriate. By limiting access to needed information, the patient's privacy can be increased. For example, pharmacists 140 would have access to prescription information but typically would not be given access to information concerning allergies, heart or liver conditions, age, weight, etc. since the checking/screening of this interaction information can be provided by software on the server 120. When a medical provider 140 feels they need access to blocked portions, the medical provider 140 can ask the patient for a patient-selected passphrase, and the patient can decide whether or not to grant access.

Embodiments can also translate network-stored information to and from foreign languages and to allow physicians 140 to electronically order diagnostic tests for patents with diagnostic labs 140.

In an embodiment, a patient carries a selected portion of their medical information, such as dental records and any information that might be of interest to dental personnel (e.g., allergies and other medical conditions) for use at a dental visit, or carries an entire copy of their medical information for medical appointments or emergencies. To accomplish this, the patient accesses the medical information database 110 over network 130 using patient PC 102 and copies the desired information onto portable data storage media 180. In a preferred embodiment, the copied information is stored in HTML files for more universal access of the data to those authorized by the patient.

If desired, the patient can control all access to their medical information by providing it to medical providers 140 only via portable data storage media 180, yet still allow central storage of information by allowing medical providers 140 to upload new information to system server 120. In other embodiments, the patient can use portable data storage media 180 for medical providers that do not have network access or for emergency situations.

In certain embodiments, parents of minor children access and control the medical information of such children. As such, portable data storage media 180 is used to carry portions related only to individual children or to carry full records for both the patient and the minor children for emergency purposes, such as when traveling. Similarly, upon authorization of a spouse, married couples carry partial or full records of their spouse on portable data storage media 180.

In a preferred embodiment, data on the portable data storage media 180 is copy-protected even after access has been allowed to prevent unauthorized copying or harvesting of the stored information. An applet can also be included that clears the browser cache upon removal of the portable data storage media 180 from the computer of medical provider 140.

Patients that are very concerned with privacy of their medical information can copy only the minimum information required for a particular event (i.e., visit to medical provider 140) on read-only data storage media 180, such as a CD-R disc, and then physically destroy the media (e.g., disc) immediately after the event to prevent any misuse of the information.

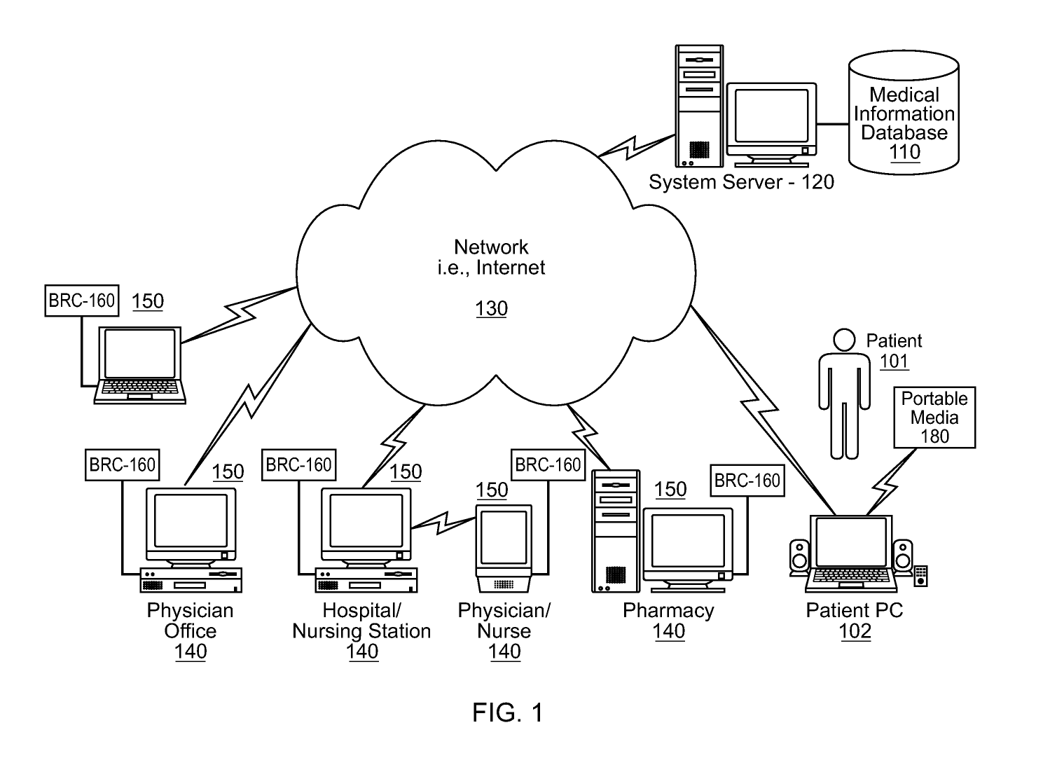

Additionally, as illustrated in FIG. 1, PDAs 150 are “connected” to the network 130 through standard syncing with a computer 150 which is connected to the network.

In other embodiments, medical providers 140 in very specific fields, such as dentistry, will have their own electronic medical record system and will need access to very little “outside” medical information. In these cases, appropriate or relevant “outside” medical information concerning the patient can be e-mailed to the medical provider by the server prior to a patient's appointment as an alternative to being carried on portable data storage media 180. This information can include allergies, medications, and relevant conditions such as pregnancy and heart/liver/kidney conditions.

The e-mail can be preauthorized and sent as part of a scheduling/reminder system on the server, can be sent upon a patient request, or can be sent under an auto-responder system based on patient ID when requested by a medical provider who has been given the appropriate information by the patient.

Updated information from the patient visit to the medical provider can be attached to a reply e-mail and, if necessary, translated by software on the server or otherwise sent to the server, by mail, fax, html form, etc., to update the patient medical record on the medical information database.

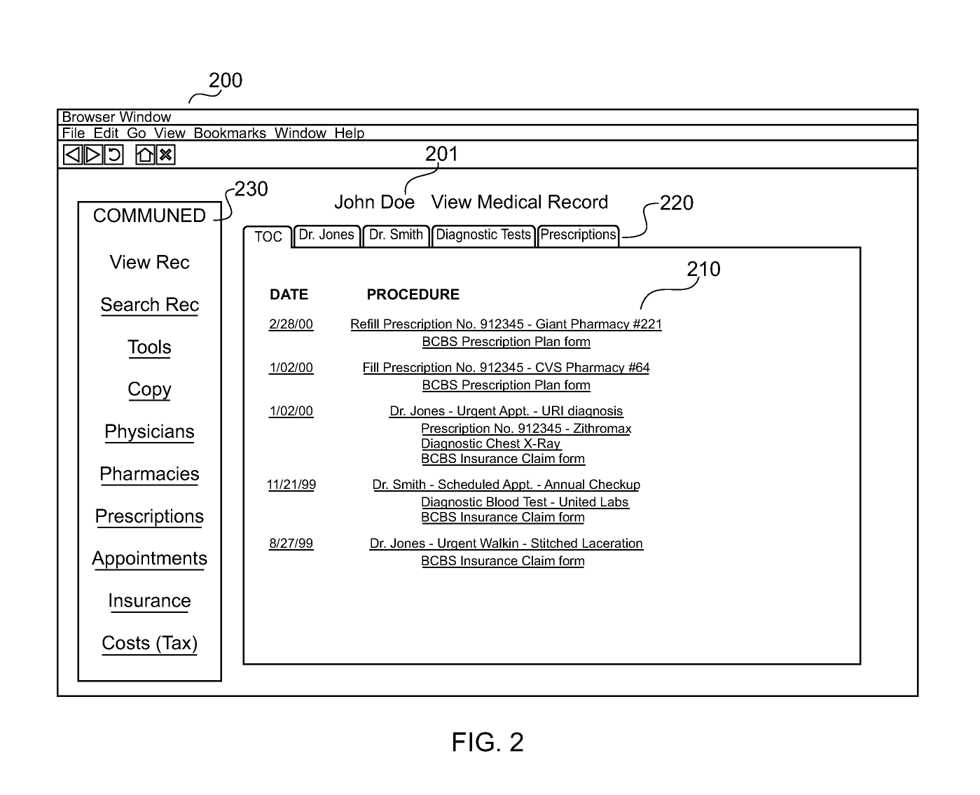

Patients can access their medical data via a standard Web browser (preferably with strong encryption) and can use server-based software tools (using Java applets, for example) to graphically and textually access their records. Although access is shown through a patient PC 102, any other network-enabled browsing device can be used, including but not limited to hand-held computers (PDAs), WAP-enabled wireless phones, automobile-mounted computers, TV set-top browser systems, and Internet-specific browsing devices. Access can be controlled by a server-set cookie or patient-supplied alphanumeric identifier in combination with a patient-supplied passphrase. FIG. 2 illustrates an example of a display screen from a browser 200 for patient access to their medical record. In this example, a patient 201 can access records from various medical events or procedures by selecting hypertext links 210 to view portions of their record. In the disclosed embodiment, hypertext links to the records can be chosen from a chronological table of contents (TOC), or from other categorized sections 220 such as by doctor, by diagnostic test, by prescription, etc. The browser window can also provide a menu 230 for selecting other tools for viewing data from the patient's record.

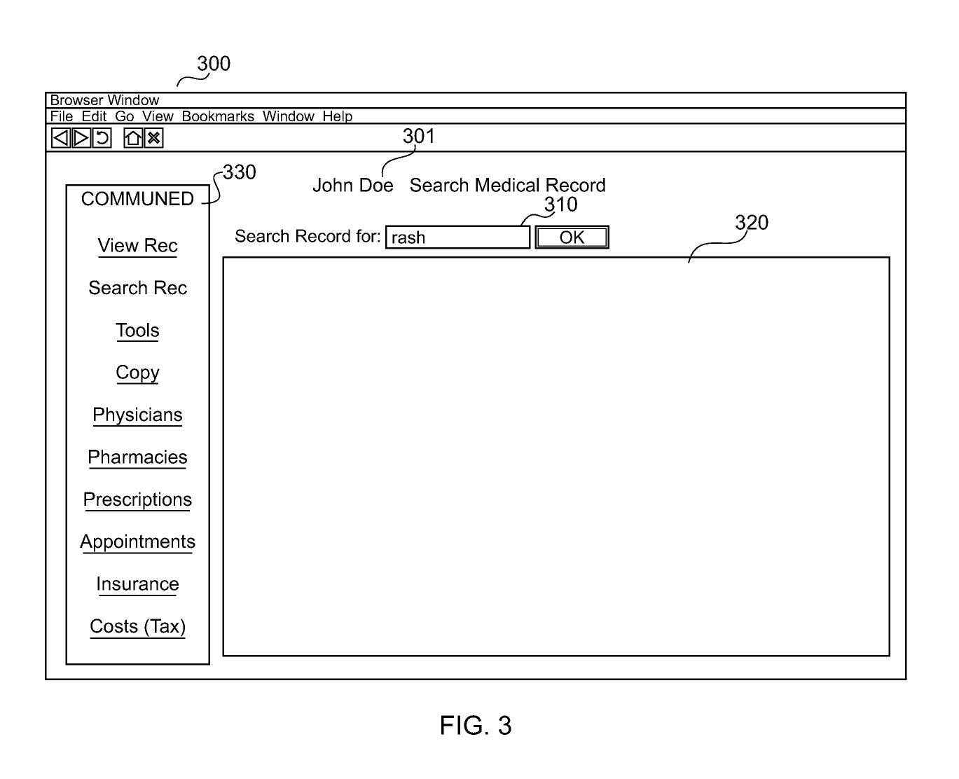

FIG. 3 illustrates a second example of a display screen from a browser 300 for patient access to their medical record from the “Search Rec” menu choice. In this example, a patient 301 can access records from various medical events or procedures by searching for text or keywords. The desired text or keyword is entered into a search box 310 and results can be displayed in viewing box 320. The results can be listed as hypertext links and navigation back to the list of results can be accomplished using a standard back button of the browser. Access to other viewing tools is provided by menu 330.

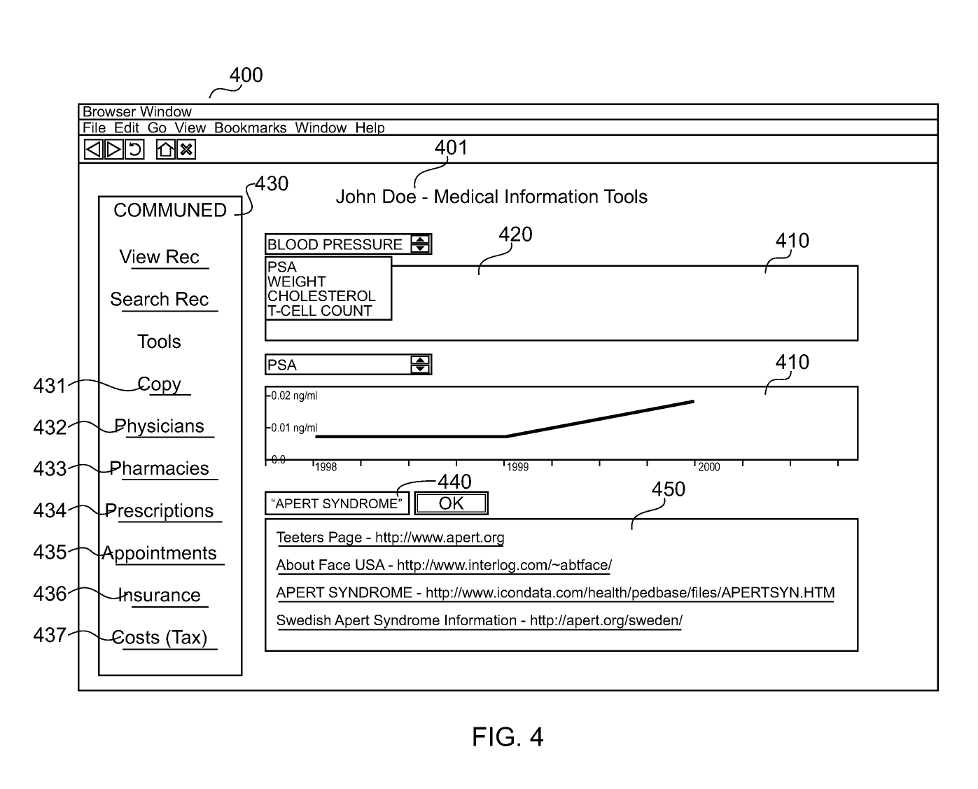

FIG. 4 illustrates a third example of a display screen from a browser 400 for patient access to their medical record that includes viewing tools from the “Tools” menu choice. In this example, a patient 401 can access graphs 410 of specific medical indicia, such as blood pressure, PSA, weight, cholesterol level, t-cell count, etc., over time chosen from pull down menu 420. Although only one graph 410 would typically be needed, two have been shown for clarity. In addition to the previously described viewing tool menu 430, the window can also include a network or Internet search box 440 and viewing box 450. Again, the results can be listed as hypertext links and navigation back to the list of results can be accomplished using a standard back button of the browser.

Additional viewing tools from menu 430 can include other such pages. A “Copy” page 431 could provide an interface for copying selected medical information to portable data storage media. The patient-selected medical information and applets for access and security appropriate for the selected media can then be copied to the patient-carried portable data storage media.

A “Physicians” page 432 lists the names, addresses, phone numbers, e-mail, and Web page URLs for each of a patient's physicians. This page alternatively, but without limitation, may include selectable links for driving directions/maps, web-to-phone calling, e-mailing, physician home pages, Web-based appointment scheduling, etc.

A “Pharmacies” page 433 lists the names, addresses, phone numbers, e-mail, and Web page URLs for each of a patient's pharmacies. This page may, without limitation, also include selectable links for driving directions/maps, web-to-phone calling, e-mailing, pharmacy home pages, Web-based prescription refilling, etc.

A “Prescriptions” page 434 lists the medication, dosage, prescribing physician, and prescription number for each of a patient's prescriptions. This page may, without limitation, also include selectable links for applicable drug information, driving directions/maps to pharmacies, web-to-phone pharmacy calling, e-mail refilling, pharmacy home pages, Web-based prescription refilling, etc.

An “Appointments” page 435 lists the dates, times, names, addresses, phone numbers, e-mail, and Web page URLs for each of a patient's scheduled appointments. This page may, without limitation, also include selectable links for driving directions/maps, web-to-phone calling, e-mailing, appointment web pages, Web-based appointment scheduling, recommended dates for future appointments, etc.

An “Insurance” page 436 lists the names, addresses, phone numbers, e-mail, and Web page URLs for each of a patient's medical insurers. This page may, without limitation, also include selectable links for driving directions/maps, web-to-phone calling, e-mailing, medical insurer home pages, Web-based claim submission and tracking, etc.

A “Costs (Tax)” page 437 lists the payee (name, address), date, amount, form of payment, procedure paid for, amount covered by insurance, etc. for each item of a patient's medical costs. This page may, without limitation, also include selectable links for searching external tax information, exporting data for tax purposes (i.e. TurboTax™ from Intuit™, exporting data for financial purposes (i.e. Quicken™ from Intuit™), printing “receipts”, etc.

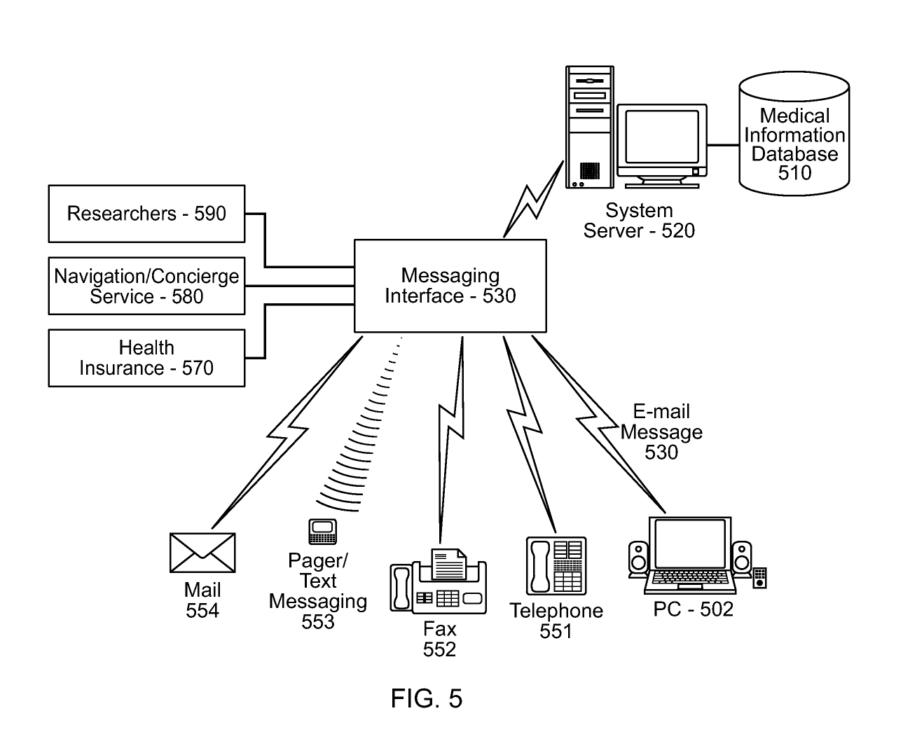

FIG. 5 illustrates some of the options with respect to parties and communication mediums for interfacing with the various embodiments illustrated herein.

Embodiments can be set up to schedule and keep track of medical appointments, and can even use server 520 and a suitable messaging interface 530 to notify the patient by e-mail 503 to their PC 502, by recorded message to telephone 551, by facsimile transmission to fax 552, by wireless text messaging to pager or text-messaging phone 553, or by postcard in mail 554 of impending appointments or adjustments to appointments, such as cancellations. It can also be used to verify that appointments have been kept, by offering, for example, email notification to the family/caretaker of Alzheimer patients. Important messages from the system server 520 regarding information, such as medication recalls or results of diagnostic tests, can also be delivered over these channels. Patients can select which of these services they prefer.

Messaging interface 530 can also use these channels for other types of services. For example, insurance claim forms can be automatically generated by server 520 and sent to the patient's health insurance 570 via computer communication, fax 552 or mail 554. The system can also be tied in with third parties, including navigation/concierge services 580, such as ONSTAR®, so a patient-subscriber can, when it traveling, be directed to the nearest hospital, doctor, or pharmacy by the shortest route and have their pertinent medical information forwarded by server 520 to the location. The navigation/concierge services 580 could contact a part of messaging interface 530 with the patient's request, and server 520 could send the information to the appropriate medical provider's computer or have the messaging interface 530 forward it by fax 552.

Embodiments can also be used, with the patient's permission, by medical researchers 590. As an example, pharmaceutical companies could verify reliability and effectiveness of the dosages of medications. The system server 520 could search or flag appropriate patients, send e-mail or browser-form questionnaires to patient PC's 502 and forward results to researchers 590. The system allows the advantages of a large patient database and the information gathering can be accomplished without revealing the patient's name, but rather by using such statistics as age, sex, health status, other medications taken, previous illness, etc. Part of the business plan for the system can include compensation by researchers for access to this valuable database.

A portion of the messaging interface 530 can also interact with mail 554 and fax 552 to input ordinary paper records into the data base 510. This function, preferably using electronic scanning and optical character recognition (OCR) technology, is useful for various situations. Its primary use is for initially transferring a patient's records from a hard copy format to an electronic format when initiating use of the service. It can also be used for maintaining/updating the patient's electronic medical record with patient-acquired hard copy records after the patient has visited a non-networked, uncooperative, or otherwise non-participating medical provider. Any suitable form of data capture, even manual input, can be used for the transfer.

Also, in regard to maintaining a complete and accurate record, messaging interface 530 could be used to import patient medical records from other systems. One use for this would be the transfer of electronic medical records from the military before their destruction upon a patient's discharge from the military. Another use for this would be the collection of a patient's medical information from publicly-available and commercial sources in order to perform an audit. If any incorrect records are discovered, appropriate action can be taken to correct the errors. If any records are found which legally violate the patient's privacy, appropriate action can be taken to have those records expunged.

In operation, the embodiments can provide numerous benefits. When the system of FIG. 1 is deployed on the Internet, the patient's medical record can be accessed from any browser connected to the Internet after authorization is given via a patient supplied identifier. When the system uses patient-carried portable data storage media, the patient's medical record or selected portions thereof, can be accessed from any browser on a computer reading the media after authorization is given via a patient supplied identifier. As a first benefit, this allows the patient's medical record to be quickly accessed when the patient is traveling.

Patients can also get second opinions without the embarrassment of asking the first physician to forward their medical record to the second physician. In this scenario, the patient supplied identifier the can be used by the second physician to allow access the patient's medical record on the database or portable data storage media without the involvement of the first physician.

Additionally, dangerous medication interactions and mistakes can be avoided through use of the various embodiments illustrated herein. Medication interactions and correctness can be checked by the server 120 at multiple points in order to catch mistakes. When a physician prescribes a medication at an office or hospital and uploads the information via medical provider computer 140, the server 120 can be programmed to immediately check for possible interactions and flag problems, thereby allowing the physician the opportunity to prescribe an alternative medication. Additionally, since the server can access data related to the patient's weight, age, sex, allergies, etc., possibly inappropriate medications or dosages can also be flagged.

When pharmacies fill the prescriptions, the server 120 can again be programmed to check for possible interactions or dosage problems if medical provider computer 140 at the pharmacy uploads the data to the server 120. The provision of this function on the server also allows the patient to have drug interactions checked without having to have all of their prescriptions filled by the same pharmacy, as required by existing drug interaction systems.

Additionally, mistakes due to misinterpreting physician handwriting can be avoided by having the prescription downloaded from database 100 or portable data storage media 180 electronically and mistakes due to mis-filling can be avoided by requiring the pharmacist to scan the bar code of the prescribed medication to match it with the downloaded data or portable data before delivery to the patient.

When nurses or physicians dispense or deliver medical treatment to the patient in a hospital using medical provider computer 140, the system can assure: (i) proper patient identification by requiring input of a patient supplied identifier, such as a bar coded patient bracelet, prior to administering medication to the patient; (ii) proper medication by requiring input of the medication identification, such as from the bar code on the packaging, prior to administering medication to the patient; and (iii) proper dosage by requiring input of this information prior to administering medication to the patient. For delivery devices, the setting, for example, of correct dosage rates can be made a prerequisite for computer operation of the device.

To prevent mistakes, all of this input information is checked for correctness by software on the server or by an online or offline hospital system using electronic patient record information obtained from the server upon patient authorization. When a medical provider, such as a hospital, is authorized to obtain a patient's electronic medical record for offline use, a prerequisite for such authorization and use can be that the record that is updated offline by the hospital be regularly updated or synced online with the server. An additional prerequisite can be that the electronic patient medical record information obtained from the server be removed or expunged from the medical provider's offline usage system when treatment is completed. If the information is provided offline on portable data storage media, the prerequisite can be destruction or erasure of the media.

The system can also be used by hospitals and pharmacies for inventory control and automatic reordering since medications/dosages are input into the patient medical record when dispensed. As part of the business plan, the system could be programmed to track medical provider inventories, generate inventory reports, and/or automatically reorder supplies for a fee.

Embodiments can also be used to contact physicians and patients immediately after diagnostic labs have posted test results in a patient's electronic medical record.

Although providing medical provider access to electronic medical records on the data base and ability to add/modify records on the data base is part of the various embodiments illustrated herein, software for providing these functions has already been developed in the prior art and the necessary programming and data base design for the various embodiments described herein is well within the ability of the ordinary practitioner.

While the description above refers to particular embodiments, it will be understood that many modifications may be made without departing from the scope of the inventions as claimed. The accompanying claims are intended to cover such modifications as would fall within the scope of the claims presented. The disclosed embodiments are therefore to be considered as illustrative and not as restrictive. The scope of the invention is defined by the appended claims.

A system and method for providing patient-controlled medical information have been described. It will be understood by those skilled in the art that the embodiments presented as illustrative herein may occur in other specific forms without departing from the scope of the invention disclosed and that the examples and embodiments described herein are in all respects illustrative and not restrictive. Those skilled in the art of the present invention will recognize that other embodiments using the concepts described herein are also possible. Further, any reference to claim elements in the singular, for example, using the articles “a,” “an,” or “the” is not to be construed as limiting the element to the singular.

What is claimed is:

1. A patient-controlled electronic medical record system comprising:
a medical information server connected to a network;
a medical information database connected to the medical information server;
a patient medical record stored on the medical information database;
means for the patient to access portions of the medical record using browser software on a computer connected to the network;
means for the patient to copy selected portions of the medical record to portable data storage media;
means for the patient to allow a medical provider computer to access a patient-selected portion of the patient medical record from the portable data storage media; and
medical provider computer software to view the patient-selected portion of the patient's medical record from the portable data storage media.

2. The patient-controlled electronic medical record system of claim 1, wherein the medical information server includes instructions for formatting the patient-selected medical data from the patient medical record for viewing and copying by the patient.

3. The patient-controlled electronic medical record system of claim 1, wherein the means for the patient to allow medical provider computers to access a patient-selected portion of the patient medical record from the portable data storage media is selected from the group consisting of patient-supplied passphrases, biometric access controls, and emergency access overrides supplied by the system server.

4. The patient-controlled electronic medical record system of claim 1, wherein the patient-selected portion of the patient medical record is formatted as hypertext markup language (HTML) and the medical provider computer software is a browser client.

5. The patient-controlled electronic medical record system of claim 1, wherein the server comprises instructions for responding to patient-preauthorized requests from third parties and for electronically transmitting the patient medical record information to a remote location.

6. The patient-controlled electronic medical record system of claim 1, wherein the network is a public network.

7. The patient-controlled electronic medical record system of claim 6, wherein the public network is the Internet.

8. The patient-controlled electronic medical record system of claim 1, wherein the means for patients to allow medical provider computers to access patient-selected portions of the patient's medical record from the portable data storage media is a patient-supplied unique access identification means.

9. The patient-controlled electronic medical record system of claim 8, wherein the patient-supplied unique access identification means is selected from the group consisting of alpha-numeric passphrases, smart cards, biometric samples, bar coded cards, and bar coded bracelets.

10. The patient-controlled electronic medical record system of claim 1, further comprising means for transferring hard copy medical record information into an electronic format for storage in the medical information database.

11. A method for patient control of an electronic medical record comprising:
connecting a medical information server to a network;
connecting a medical information database to the medical information server;
storing a patient medical record on the medical information database;
allowing a patient to access the patient medical record using browser software on a computer connected to the network;
allowing the patient to copy a selected portion of the patient medical record to a portable data storage media;
allowing a medical provider computer to access the patient-selected portion of the patient medical record from the portable data storage media upon use of a patient-supplied unique access identification means; and
allowing the medical provider computer to view portions of the patient medical record from the portable data storage media.

12. The method for patient control of an electronic medical record of claim 11, further comprising the medical information server software formatting the patient-selected medical data from the patient medical record for viewing and copying by the patient.

13. The method for patient control of an electronic medical record of claim 11, wherein allowing medical provider computers to access patient-selected portions of the patient's medical record from the portable data storage media further comprises conditioning access on the entry of patient-supplied passphrases, biometric access controls, and emergency access overrides supplied by the system server.

14. The method for patient control of an electronic medical record of claim 11, further comprising the medical information server formatting the patient-selected medical data from the patient medical record as hypertext markup language (HTML) and using the browser on the medical provider computer to view accessed portions of the patient medical record from the portable data storage media.

15. The method for patient control of an electronic medical record of claim 11, further comprising the server responding to patient-preauthorized requests from third parties to electronically transmit the patient medical record information to a remote location.

16. The method for patient control of an electronic medical record of claim 11, wherein the network used is a public network.

17. The method for patient control of an electronic medical record of claim 16, wherein the public network used is the Internet.

18. The method for patient control of an electronic medical record of claim 11, wherein allowing the medical provider computer to access the patient-selected portion of the patient medical record from the portable data storage media comprises conditioning access on use an identifier selected from the group consisting of alpha-numeric passphrases, smart cards, biometric samples, bar coded cards, and bar coded bracelets.

19. The method for patient control of an electronic medical record of claim 11, further comprising transferring hard copy medical record information into an electronic format for storage in the medical information database.
